(19) United States
(12) Patent Application Publication
(10) Pub. No.: US 2025/0309398 A1
(43) Pub. Date: Oct. 2, 2025

(54) BATTERY MODULE

(71) Applicant: TOYOTA JIDOSHA KABUSHIKI KAISHA, Toyota-shi (JP)

(72) Inventors: Satomi YAMAMOTO, Miyoshi-shi (JP); Yuzo Miura, Toyota-shi (JP); Takashi Gouda, Toyota-shi (JP); Yusuke Kuruma, Toyota-shi (JP); Hiroaki Yamamichi, Takahama-shi (JP); Haruka Tsuruta, Toyota-shi (JP); Yasumasa Oguma, Nagoya-shi (JP)

(73) Assignee: TOYOTA JIDOSHA KABUSHIKI KAISHA, Toyota-shi (JP)

(21) Appl. No.: 18/966,728

(22) Filed: Dec. 3, 2024

(30) Foreign Application Priority Data
Mar. 26, 2024 (JP) 2024-048983

(51) Int. Cl. H01M 10/6551; H01M 10/613; H01M 10/625; H01M 10/653; H01M 10/6555; H01M 10/658; H01M 50/204; H01M 50/258; H01M 50/293

(52) U.S. Cl. CPC H01M 10/6551; H01M 10/613; H01M 10/625; H01M 10/653; H01M 10/6555; H01M 10/658; H01M 50/204; H01M 50/258; H01M 50/293; H01M 2220/20

(57) ABSTRACT

A battery module, wherein: the battery module includes battery cells, a heat insulation member, and first heat dissipation members as heat dissipation members; the battery module includes, as the battery cells, at least a first battery cell and a second battery cell; the first heat dissipation members are disposed respectively adjacent to the battery cells; the heat insulation member is disposed between the first battery cell and the second battery cell; and a ratio of the thermal resistance of the heat insulation member to the thermal resistance of the heat dissipation member (the thermal resistance of the heat insulation member/the thermal resistance of the heat dissipation member) is 0.0102 or higher.

### CROSS-REFERENCE TO RELATED APPLICATION

This application claims priority to Japanese Patent Application No. 2024-048983 filed on Mar. 26, 2024, incorporated herein by reference in its entirety.

### BACKGROUND

### 1. Technical Field

This disclosure relates to a battery module.

### 2. Description of Related Art

Regarding battery modules like the one disclosed in Japanese Unexamined Patent Application Publication (Translation of PCT Application) No. 2022-549926 (JP 2022-549926 A), various technologies have been proposed.

### SUMMARY

In the related art, a battery module including heat insulation members between a plurality of cells, a heat dissipation member sandwiched between the heat insulation members, and a heat sink in contact with the heat dissipation member has been disclosed. There is room for further improvement from the viewpoint of inhibiting transfer of heat generated from one cell to an adjacent cell.

This disclosure has been made in view of the above-described current situation, and a main object thereof is to provide a battery module that can inhibit transfer of heat generated from one cell to an adjacent cell.

Specifically, this disclosure includes the following aspects:
<1> A battery module, wherein:
the battery module includes battery cells, a heat insulation member, and first heat dissipation members as heat dissipation members;
the battery module includes, as the battery cells, at least a first battery cell and a second battery cell;
the first heat dissipation members are disposed respectively adjacent to the battery cells;
the heat insulation member is disposed between the first battery cell and the second battery cell; and
a ratio of the thermal resistance of the heat insulation member to the thermal resistance of the heat dissipation member (the thermal resistance of the heat insulation member/the thermal resistance of the heat dissipation member) is 0.0102 or higher.
<2> A battery module, wherein:
the battery module includes battery cells, two heat insulation members, and first heat dissipation members and a second heat dissipation member as heat dissipation members;
the battery module includes, as the battery cells, at least a first battery cell and a second battery cell;
the first heat dissipation members are disposed respectively adjacent to the battery cells;
the two heat insulation members are disposed between the first battery cell and the second battery cell; and
the second heat dissipation member is disposed sandwiched between the two heat insulation members.
<3> The battery module according to <1> or <2>, wherein the thickness of the heat dissipation member is smaller than the thickness of the first battery cell and the second battery cell.
<4> The battery module according to any one of <1> to <3>, wherein the heat dissipation member is composed of a heat dispersion plate and a thermally conductive material.
<5> A battery pack including the battery module according to any one of <1> to <4>, a pack case that houses the battery module, and a cooler that cools the battery module.

This disclosure can provide a battery module that can inhibit transfer of heat generated from one cell to an adjacent cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view showing one example of a first embodiment of a battery pack of this disclosure;

FIG. 2 is a schematic sectional view showing one example of a second embodiment of the battery pack of this disclosure;

FIG. 3 is a graph showing a relationship between a thermal resistance ratio (heat insulation member thermal resistance/first heat dissipation member thermal resistance) and a temperature reached by an adjacent cell (second battery cell) through the heat insulation member; and

FIG. 4 is a graph showing a relationship between the thickness of the heat insulation member and the temperature reached by the adjacent cell (second battery cell) through the heat insulation member.

### DETAILED DESCRIPTION OF EMBODIMENTS

In the following, embodiments according to this disclosure will be described. Items that are other than items particularly mentioned in this Description and that are needed to implement this disclosure (e.g., a battery module that does not characterize this disclosure) can be regarded as design items for those skilled in the art based on the related art in this field. This disclosure can be implemented based on the contents disclosed in this Description and technical common knowledge in this field.

In a first embodiment of this disclosure, a battery module is provided, wherein:
the battery module includes battery cells, a heat insulation member, and first heat dissipation members as heat dissipation members;
the battery module includes, as the battery cells, at least a first battery cell and a second battery cell;
the first heat dissipation members are disposed respectively adjacent to the battery cells;
the heat insulation member is disposed between the first battery cell and the second battery cell; and
a ratio of the thermal resistance of the heat insulation member to the thermal resistance of the heat dissipation member (the thermal resistance of the heat insulation member/the thermal resistance of the heat dissipation member) is 0.0102 or higher.

In a second embodiment of this disclosure, a battery module is provided, wherein:
the battery module includes battery cells, two heat insulation members, and first heat dissipation members and a second heat dissipation member as heat dissipation members;
the battery module includes, as the battery cells, at least a first battery cell and a second battery cell;
the first heat dissipation members are disposed respectively adjacent to the battery cells;
the two heat insulation members are disposed between the first battery cell and the second battery cell; and
the second heat dissipation member is disposed sandwiched between the two heat insulation members.

The battery module of this disclosure includes the first battery cell, the second battery cell, the at least one heat insulation member, and at least the first heat dissipation members as the heat dissipation members.

The first battery cell and the second battery cell will be collectively referred to as battery cells (and may be simply referred to as cells).

The second battery cell is disposed adjacent to the first battery cell.

The battery module should include at least the two battery cells of the first battery cell and the second battery cell as the battery cells, and may include three or more battery cells.

The battery cell may have a positive electrode including a positive electrode current collector and a positive electrode layer, an electrolyte layer, and a negative electrode including a negative electrode layer and a negative electrode current collector.

The battery cell may include the positive electrode current collector, the positive electrode layer, the electrolyte layer, the negative electrode layer, and the negative electrode current collector in this order.

The battery cell may be a conventionally widely known battery, and may be a liquid battery or may be a solid-state battery.

A solid-state battery in this disclosure means a battery including a solid electrolyte. The solid-state battery may be a semi-solid-state battery that is a solid-state battery including a solid electrolyte and a liquid material, or may be an all-solid-state battery that is a solid-state battery not including a liquid material. The battery may be a primary battery or may be a secondary battery.

The heat insulation member is disposed between the first battery cell and the second battery cell. When the battery module includes three or more battery cells, the heat insulation member may be disposed between each battery cell of the three or more battery cells. In the first embodiment of this disclosure, at least one heat insulation member may be disposed between each of the battery cells. In the second embodiment of this disclosure, at least two heat insulation members (a first heat insulation member and a second heat insulation member) may be disposed between each of the battery cells.

When the battery module includes two or more heat insulation members, each of the heat insulation members may be made of the same material or may be made of different materials.

The heat insulation member may be a conventionally widely known material.

In the first embodiment of this disclosure, the first heat dissipation members are included as the heat dissipation members. In the second embodiment of this disclosure, the first heat dissipation members and the second heat dissipation member are included as the heat dissipation members. In this disclosure, the first heat dissipation members and the second heat dissipation member will be collectively referred to as heat dissipation members.

The heat dissipation member may be a conventionally widely known material, and may be a metal material such as aluminum, a carbon material such as carbon, etc.

From the viewpoint of reducing the thermal resistance, the thickness of the heat dissipation member may be smaller than the thickness of the first battery cell and the second battery cell. When the battery module includes three or more battery cells, the thickness of the heat dissipation member may be smaller than the thickness of each cell of the three or more battery cells.

The heat dissipation member includes a heat dispersion plate and further includes a thermally conductive material as necessary. The heat dispersion plate and the thermally conductive material may be the same material or may be different materials.

The thermally conductive material may be a thermally conductive sheet.

The first heat dissipation members are disposed respectively adjacent to the battery cells.

The first heat dissipation members may be disposed between each of the battery cells and the heat insulation member and may be disposed on a side of another battery cell opposite from a side adjacent to the heat insulation member.

The heat dispersion plates of the first heat dissipation members may be disposed between each of the battery cells and the heat insulation member and may be disposed on the side of another battery cell opposite from the side adjacent to the heat insulation member.

The thermally conductive material of each first heat dissipation member may be disposed between the heat dispersion plate of the first heat dissipation member and a cooler. The thermally conductive material of each first heat dissipation member may be disposed between the heat dispersion plate of the first heat dissipation member and a pack case.

The second heat dissipation member is disposed sandwiched between the two heat insulation members.

The heat dispersion plate of the second heat dissipation member may be disposed between the two heat insulation members.

The thermally conductive material of the second heat dissipation member may be disposed between the heat dispersion plate of the second heat dissipation member and the cooler. The thermally conductive material of the second heat dissipation member may be disposed between the heat dispersion plate of the second heat dissipation member and the pack case.

For the thermally conductive material of the second heat dissipation member, insulation between itself and the battery cells is secured by the heat insulation members and thus there is no need to secure the insulation, which allows a measure for lowering the thermal resistance to be taken.

The thickness of the second heat dissipation member may be smaller than the thickness of the battery cell, and may be equal to or smaller than the thickness of the first heat dissipation member.

The thicknesses of the heat dispersion plate and the thermally conductive material of the second heat dissipation member may be smaller than the thickness of the battery cell, and may be equal to or smaller than the thicknesses of the heat dispersion plate and the thermally conductive material of the first heat dissipation member. The thermal conductivity of the thermally conductive material of the second heat dissipation member may be higher than the thermal conductivity of the thermally conductive material of the first heat dissipation member. Setting the thermal resistance of the second heat dissipation member lower than the thermal resistance of the heat insulation member can inhibit heat conduction to an adjacent battery cell and effectively disperse heat to the cooler or the pack case, as well as allow space savings.

In the first embodiment of this disclosure, the ratio of the thermal resistance of the heat insulation member to the thermal resistance of the heat dissipation member (the thermal resistance of the heat insulation member/the thermal resistance of the heat dissipation member) should be 0.0102 or higher. In the second embodiment of this disclosure, the ratio of the thermal resistance of the heat insulation member to the thermal resistance of the heat dissipation member (the thermal resistance of the heat insulation member/the thermal resistance of the heat dissipation member) may be 0.0102 or higher. In this disclosure, from the viewpoint of being able to further inhibit transfer of heat generated from one cell to an adjacent cell, the lower limit may be 0.0308 or higher, 0.0925 or higher, 0.1542 or higher, 0.3084 or higher, or 0.8325 or higher.

In this disclosure, from the viewpoint of inhibiting an increase in the thickness of the heat insulation member, allowing space savings, and achieving improvement of the energy density of the battery module, the upper limit of the ratio of the thermal resistance of the heat insulation member to the thermal resistance of the heat dissipation member (the thermal resistance of the heat insulation member/the thermal resistance of the heat dissipation member) may be 30.8400 or lower, 15.4200 or lower, 7.4925 or lower, or 2.4975 or lower. As for the calculation method, the thermal resistance of the heat dissipation member and the thermal resistance of the heat insulation member are calculated from the following Formula (1):

$$( 1 / thermal conductivity ) \cdot distance / cross - sectional area \qquad ( 1 )$$

As heat moves in a thickness direction of the heat insulation member, the distance in the calculation of the thermal resistance of the heat insulation member is the thickness of the heat insulation member.

As heat moves from the heat dispersion plate of the heat dissipation member to the thermally conductive material of the heat dissipation member disposed between the heat dispersion plate and the cooler or the pack case, the distance in the calculation of the thermal resistance of the heat dissipation member is the distance from a center part in a cross-section of the heat dissipation member to an end portion thereof.

A battery pack of this disclosure includes the battery module of this disclosure, a pack case that houses the battery module, and a cooler that cools the battery module.

The pack case is not particularly limited as long as it can house the battery module.

At least either the cooler or the pack case may be disposed adjacent to the thermally conductive material of the heat dissipation member.

The cooler may be housed inside the pack case, or may be disposed outside the pack case, or may be disposed adjacent to the pack case.

As the cooler, a conventionally widely known one can be adopted as appropriate, and the cooler may be a soaking plate.

Examples of purposes of the battery module of this disclosure include a power source of a vehicle such as a hybrid electric vehicle (HEV), a plug-in hybrid electric vehicle (PHEV), a battery electric vehicle (BEV), a gasoline car, or a diesel car. In particular, the battery module may be used as a driving power source of a hybrid electric vehicle (HEV), a plug-in hybrid electric vehicle (PHEV), or a battery electric vehicle (BEV). In addition, the battery module may be used as a power source of a mobile body other than vehicles (e.g., a railroad, a ship, or an airplane), or may be used as a power source of an electrical product, such as an information processing device.

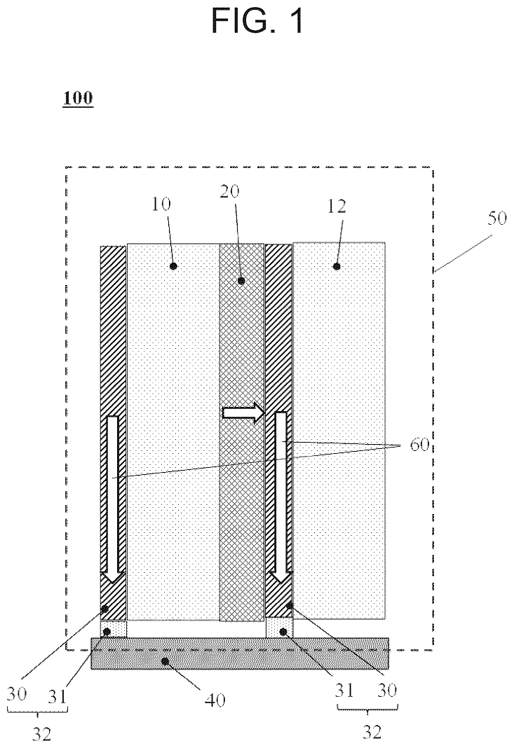

FIG. 1 is a schematic sectional view showing one example of a first embodiment of the battery pack of this disclosure.

A battery pack 100 includes a cooler 40 and a battery module 50. The battery module 50 is housed in a pack case (not shown).

The battery module 50 includes a first battery cell 10, a second battery cell 12, a heat insulation member 20, and first heat dissipation members 32 each including a heat dispersion plate 30 and a thermally conductive material 31.

The second battery cell 12 is disposed adjacent to the first battery cell 10.

The heat insulation member 20 is disposed between the first battery cell 10 and the second battery cell 12.

One first heat dissipation member 32 is disposed on a side of the first battery cell 10 opposite from a side in contact with the heat insulation member 20, and another heat dissipation member 32 is disposed between the second battery cell 12 and the heat insulation member 20.

The thermally conductive material 31 of each first heat dissipation member 32 is disposed under the heat dispersion plate 30, between the heat dispersion plate 30 and the cooler 40.

The cooler 40 is disposed under the thermally conductive materials 31 of the first heat dissipation members 32.

The thickness of the first heat dissipation members 32 is smaller than the thickness of the first battery cell 10 and the second battery cell 12.

The thermally conductive materials 31 serve as thermal paths of the heat dispersion plates 30.

Heat 60 moves from the heat dispersion plate 30 of each first heat dissipation member 32 to the thermally conductive material 31 disposed under the heat dispersion plate 30.

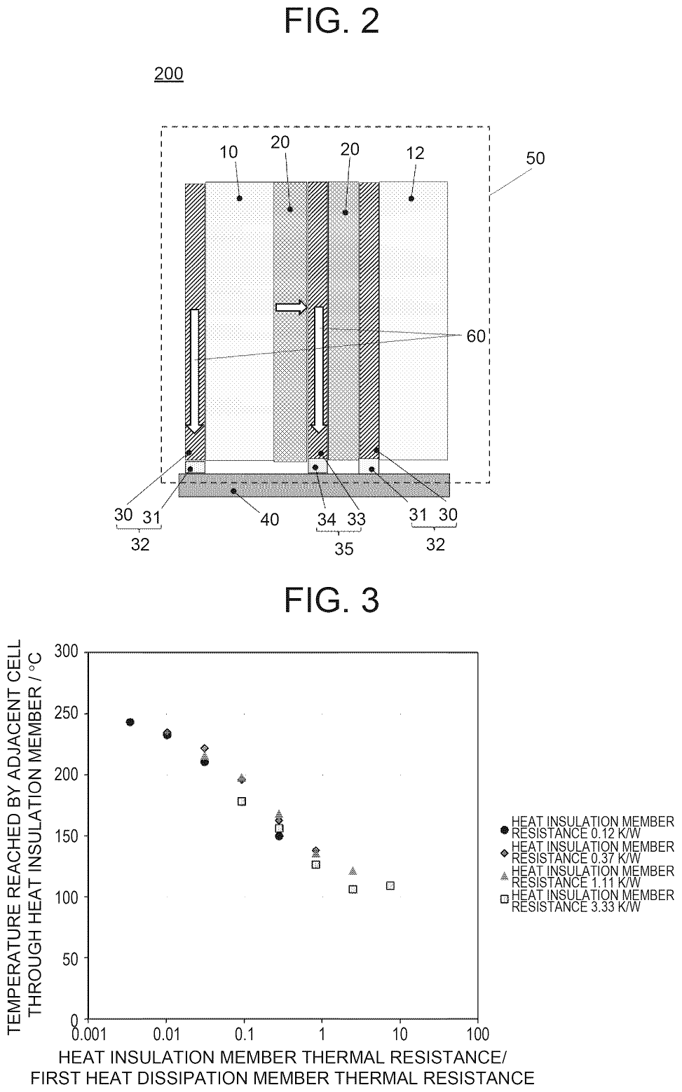

FIG. 2 is a schematic sectional view showing one example of a second embodiment of the battery pack of this disclosure.

A battery pack 200 includes a cooler 40 and a battery module 50. The battery module 50 is housed in a pack case (not shown).

The battery module 50 includes a first battery cell 10, a second battery cell 12, two heat insulation members 20 (a first heat insulation member and a second heat insulation member), first heat dissipation members 32 each including a heat dispersion plate 30 and a thermally conductive material 31, and a second heat dissipation member 35 including a heat dispersion plate 33 and a thermally conductive material 34.

The second battery cell 12 is disposed adjacent to the first battery cell 10.

The two heat insulation members 20 are disposed between the first battery cell 10 and the second battery cell 12.

One first heat dissipation member 32 is disposed on a side of the first battery cell 10 opposite from a side in contact with the heat insulation member 20, and another heat dissipation member 32 is disposed between the second battery cell 12 and the heat insulation member 20.

The thermally conductive material 31 of each first heat dissipation member 32 is disposed under the heat dispersion plate 30, between the heat dispersion plate 30 and the cooler 40.

The second heat dissipation member 35 is disposed sandwiched between the two heat insulation members 20.

The thermally conductive material 34 of the second heat dissipation member 35 is disposed under the heat dispersion plate 33, between the heat dispersion plate 33 and the cooler 40.

The cooler 40 is disposed under the thermally conductive materials 31 of the first heat dissipation members 32 and the thermally conductive material 34 of the second heat dissipation member 35.

The thickness of the first heat dissipation members 32 and the second heat dissipation member 35 is smaller than the thickness of the first battery cell 10 and the second battery cell 12.

The thermally conductive materials 31 serves as thermal paths of the heat dispersion plates 30. The thermally conductive material 34 serves as a thermal path of the heat dispersion plate 33.

Heat 60 moves from the heat dispersion plates 30 of the first heat dissipation members 32 to the thermally conductive materials 31 disposed under the heat dispersion plates 30.

The heat 60 moves also in a thickness direction of the heat insulation member 20, and moves from the heat dispersion plate 33 of the second heat dissipation member 35 to the thermally conductive material 34 disposed under the heat dispersion plate 33. Thus, the heat 60 can be inhibited from moving to the second battery cell 12.

### Examples 1 to 19, Comparative Example 1

### First Embodiment

In Examples 1 to 19 and Comparative Example 1, battery modules were used that each included a predetermined first battery cell, a predetermined second battery cell, first heat dissipation members (each including a heat dispersion plate and a thermally conductive material) disposed respectively adjacent to the battery cells, and one heat insulation member disposed between the first battery cell and the second battery cell.

The four types of heat insulation members shown in Table 1 that were different from one another in the thermal resistance were prepared.

The thermal resistance 0.1200 K/W of the heat insulation member is the thermal resistance of a heat insulation member having a thickness of 0.1200 mm.

The thermal resistance 0.3700 K/W of the heat insulation member is the thermal resistance of a heat insulation member having a thickness of 0.3700 mm.

The thermal resistance 1.1100 K/W of the heat insulation member is the thermal resistance of a heat insulation member having a thickness of 1.1100 mm.

The thermal resistance 3.3300 K/W of the heat insulation member is the thermal resistance of a heat insulation member having a thickness of 3.3300 mm.

Using one of the four types of heat insulation members and one of a plurality of types of first heat dissipation members different from one another in the thermal resistance, battery modules of Examples 1 to 19 and Comparative Example 1 were prepared that were different from one another at least either in the thermal resistance of the heat insulation member and in the heat insulation member thermal resistance/the first heat dissipation member thermal resistance.

The predetermined first battery cell of each of the battery modules of Examples 1 to 19 and Comparative Example 1 was heated to 898° C. and a temperature reached by the adjacent cell (predetermined second battery cell) through the heat insulation member was measured.

The thermal resistance of the heat insulation member, the first heat dissipation member thermal resistance, the heat insulation member thermal resistance/the first heat dissipation member thermal resistance, and the temperature reached by the adjacent cell through the heat insulation member of each of Examples 1 to 19 and Comparative Example 1 are shown in Table 1.

TABLE 1

| | | | Heat insulation | |
|---|---|---|---|---|
| | Heat | First heat | member thermal | |
| | insulation | dissipation | resistance/first | Temperature |
| | member | member | heat dissipation | reached by |
| | thermal | thermal | member thermal | adjacent |
| | resistance | resistance | resistance | cell |
| | K/W | K/W | — | ° C. |
| Comparative | 0.1200 | 35.0270 | 0.0034 | 242.9 |
| Example 1 | | | | |
| Example 1 | 0.1200 | 11.7647 | 0.0102 | 232.4 |
| Example 2 | 0.1200 | 3.8919 | 0.0308 | 210.3 |
| Example 3 | 0.1200 | 1.2973 | 0.0925 | 177.7 |
| Example 4 | 0.1200 | 0.4324 | 0.2775 | 149.7 |
| Example 5 | 0.3700 | 36.2745 | 0.0102 | 234.3 |
| Example 6 | 0.3700 | 12.0000 | 0.0308 | 221.4 |
| Example 7 | 0.3700 | 4.0000 | 0.0925 | 196.1 |
| Example 8 | 0.3700 | 1.3333 | 0.2775 | 162.4 |
| Example 9 | 0.3700 | 0.4444 | 0.8325 | 138.2 |
| Example 10 | 1.1100 | 36.0000 | 0.0308 | 215.4 |
| Example 11 | 1.1100 | 12.0000 | 0.0925 | 197.8 |
| Example 12 | 1.1100 | 4.0000 | 0.2775 | 167.7 |
| Example 13 | 1.1100 | 1.3333 | 0.8325 | 135.8 |
| Example 14 | 1.1100 | 0.4444 | 2.4975 | 121.3 |
| Example 15 | 3.3300 | 36.0000 | 0.0925 | 178.0 |
| Example 16 | 3.3300 | 12.0000 | 0.2775 | 156.1 |
| Example 17 | 3.3300 | 4.0000 | 0.8325 | 126.3 |
| Example 18 | 3.3300 | 1.3333 | 2.4975 | 106.0 |
| Example 19 | 3.3300 | 0.4444 | 7.4925 | 108.9 |

FIG. 3 is a graph showing a relationship between the thermal resistance ratio (the heat insulation member thermal resistance/the first heat dissipation member thermal resistance) and the temperature reached by the adjacent cell (second battery cell) through the heat insulation member.

As shown in Table 1 and FIG. 3, it can be seen that when the ratio of the thermal resistance of the heat insulation member to the thermal resistance of the first heat dissipation member (the heat insulation member thermal resistance/the first heat dissipation member thermal resistance) is 0.0102 or higher, the temperature reached by the adjacent cell through the heat insulation member can be lowered; that when this ratio is 0.0925 or higher, the temperature reached by the adjacent cell becomes significantly lower; and that when this ratio is 0.8325 or higher, the lowering effect on the temperature reached by the adjacent cell becomes higher and stable.

### Examples 20 to 34

### Second Embodiment

In Examples 20 to 24, battery modules were used that each included a predetermined first battery cell, a predetermined second battery cell, first heat dissipation members (each including a heat dispersion plate and a thermally conductive material) disposed respectively adjacent to the battery cells and having predetermined thermal resistance (that met the heat insulation member thermal resistance/the first heat dissipation member thermal resistance of 0.0102 or higher), two heat insulation members disposed between the first battery cell and the second battery cell, and a second heat dissipation member (including only a heat dispersion plate and not including a thermally conductive material) disposed between the two heat insulation members.

In Examples 25 to 34, battery modules were used that each included a predetermined first battery cell, a predetermined second battery cell, first heat dissipation members (each including a heat dispersion plate and a thermally conductive material) disposed respectively adjacent to the battery cells and having predetermined thermal resistance (that met the heat insulation member thermal resistance/the first heat dissipation member thermal resistance of 0.0102 or higher), two heat insulation members disposed between the first battery cell and the second battery cell, and a second heat dissipation member (including a heat dispersion plate and a thermally conductive material) disposed between the two heat insulation members.

The five types of heat insulation members shown in Table 2 that were different from one another in the thickness (thermal resistance) were prepared.

Using one of the five types of heat insulation members and the second heat dissipation member including only a heat dispersion plate and not including a thermally conductive material, battery modules of Examples 20 to 24 that were different from one another in the thermal resistance of the heat insulation member were prepared.

Using one of the five types of heat insulation members and one of a plurality of types of second heat dissipation members (each including a heat dispersion plate and a thermally conductive material) that were different from one another in the thermal resistance, battery modules of Examples 25 to 34 were prepared that were different from one another at least either in the thermal resistance of the heat insulation member and in the heat insulation member thermal resistance/the second heat dissipation member thermal resistance.

The predetermined first battery cell of each of the battery modules of Examples 20 to 34 was heated to 898° C. and a temperature reached by the adjacent cell (predetermined second battery cell) through the two heat insulation members was measured.

The thermal resistance of the heat insulation member, the second heat dissipation member thermal resistance, the heat insulation member thermal resistance/the second heat dissipation member thermal resistance, and the temperature reached by the adjacent cell through the heat insulation members of each of Examples 20 to 34 are shown in Table 2.

TABLE 2

| | | | | Heat | |
|---|---|---|---|---|---|
| | | | | insulation | |
| | | | | member | |
| | | | | thermal | |
| | | | Second | resistance/ | |
| | Heat | Heat | heat | second | |
| | insu- | insu- | dissi- | heat | Temper- |
| | lation | lation | pation | dissipation | ature |
| | member | member | member | member | reached by |
| | thick- | thermal | thermal | thermal | adjacent |
| | ness | resistance | resistance | resistance | cell |
| | mm | K/W | K/W | — | ° C. |
| Example 20 | 1 | 1.542 | 10000 | — | 147.3 |
| Example 21 | 2 | 3.084 | 10000 | — | 120.6 |
| Example 22 | 3 | 4.626 | 10000 | — | 105.5 |
| Example 23 | 4 | 6.168 | 10000 | — | 95.7 |
| Example 24 | 5 | 7.710 | 10000 | — | 89.0 |
| Example 25 | 1 | 1.542 | 0.1000 | 15.4200 | 96.4 |
| Example 26 | 1 | 1.542 | 0.5000 | 3.0840 | 107.3 |
| Example 27 | 1 | 1.542 | 1.0000 | 1.5420 | 114.8 |
| Example 28 | 1 | 1.542 | 5.0000 | 0.3084 | 134.0 |
| Example 29 | 1 | 1.542 | 10.0000 | 0.1542 | 139.7 |
| Example 30 | 2 | 3.084 | 0.1000 | 30.8400 | 84.5 |
| Example 31 | 2 | 3.084 | 0.5000 | 6.1680 | 90.2 |
| Example 32 | 2 | 3.084 | 1.0000 | 3.0840 | 95.3 |
| Example 33 | 2 | 3.084 | 5.0000 | 0.6168 | 109.2 |
| Example 34 | 2 | 3.084 | 10.0000 | 0.3084 | 113.8 |

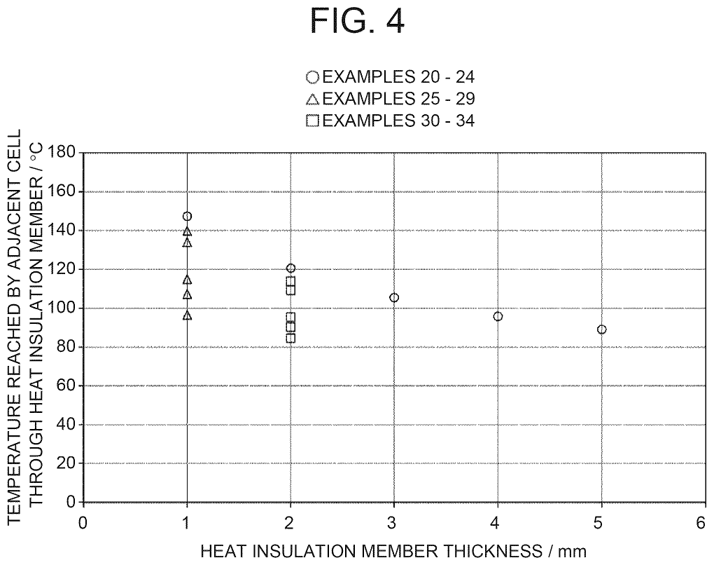

FIG. 4 is a graph showing a relationship between the thickness of the heat insulation member and the temperature reached by the adjacent cell (second battery cell) through the heat insulation member.

As shown in Table 2 and FIG. 4, it can be seen that in Examples 20 to 24, increasing the thickness of the heat insulation member can lower the temperature reached by the adjacent cell. On the other hand, as can be seen from a comparison between Example 20 and Examples 25 to 29 and a comparison between Example 21 and Examples 30 to 34, when the second heat dissipation member includes a thermally conductive material and, moreover, the ratio of the thermal resistance of the heat insulation member to the thermal resistance of the heat dissipation member (the heat insulation member thermal resistance/the heat dissipation member thermal resistance) meets a predetermined value, the temperature reached by the adjacent cell can be lowered without the thickness of the heat insulation member being increased as in Examples 22 to 24.

What is claimed is:

1. A battery module, wherein:
the battery module comprises battery cells, a heat insulation member, and first heat dissipation members as heat dissipation members;
the battery module comprises, as the battery cells, at least a first battery cell and a second battery cell;
the first heat dissipation members are disposed respectively adjacent to the battery cells;
the heat insulation member is disposed between the first battery cell and the second battery cell; and
a ratio of thermal resistance of the heat insulation member to thermal resistance of the heat dissipation member (the thermal resistance of the heat insulation member/the thermal resistance of the heat dissipation member) is 0.0102 or higher.

2. A battery module, wherein:
the battery module comprises battery cells, two heat insulation members, and first heat dissipation members and a second heat dissipation member as heat dissipation members;
the battery module comprises, as the battery cells, at least a first battery cell and a second battery cell;
the first heat dissipation members are disposed respectively adjacent to the battery cells;
the two heat insulation members are disposed between the first battery cell and the second battery cell; and
the second heat dissipation member is disposed sandwiched between the two heat insulation members.

3. The battery module according to claim 1, wherein a thickness of the heat dissipation member is smaller than a thickness of the first battery cell and the second battery cell.

4. The battery module according to claim 2, wherein a thickness of the heat dissipation member is smaller than a thickness of the first battery cell and the second battery cell.

5. The battery module according to claim 1, wherein the heat dissipation member is composed of a heat dispersion plate and a thermally conductive material.

6. The battery module according to claim 2, wherein the heat dissipation member is composed of a heat dispersion plate and a thermally conductive material.

7. A battery pack comprising the battery module according to claim 1, a pack case that houses the battery module, and a cooler that cools the battery module.

8. A battery pack comprising the battery module according to claim 2, a pack case that houses the battery module, and a cooler that cools the battery module.
